(19) United States
(12) Patent Application Publication
(10) Pub. No.: US 2024/0053915 A1
(43) Pub. Date: Feb. 15, 2024

(54) Hard Disk Snapshot Method and Apparatus Based on Openstack Platform

(71) Applicant: INSPUR SUZHOU INTELLIGENT TECHNOLOGY CO., LTD., Jiangsu (CN)

(72) Inventors: Boye ZHANG, Jiangsu (CN); Bao MA, Jiangsu (CN); Kaiyuan QI, Jiangsu (CN)

(21) Appl. No.: 18/251,231

(22) PCT Filed: Jul. 30, 2021
(86) PCT No.: PCT/CN2021/109633

§ 371 Date: Apr. 29, 2023

(30) Foreign Application Priority Data
Oct. 30, 2020 (CN) 202011189009.3

(51) Int. Cl. G06F 3/06

(52) U.S. Cl. CPC G06F 3/065; G06F 3/0619; G06F 3/067

(57) ABSTRACT

A hard disk snapshot method and apparatus based on Openstack platform. The method includes: initiating a cloud hard disk creation request based on a snapshot, and determining, on the basis of a type of a new cloud hard disk, a second storage backend that is about to accommodate the new cloud hard disk (S101); in response to the second storage backend being different from a first storage backend where an old cloud hard disk that stores the snapshot is located, and mounting the old cloud hard disk on one host machine (S103); creating the new cloud hard disk on the second storage backend on the basis of the type of the new cloud hard disk, and mounting the new cloud hard disk on the host machine (S105); and replicating the snapshot from the old cloud hard disk to the new cloud hard disk through the host machine (S107).

### CROSS-REFERENCE TO RELATED APPLICATION

The disclosure claims priority to Chinese Patent Application No. 202011189009.3, filed to the China National Intellectual Property Administration on Oct. 30, 2020 and entitled “Hard Disk Snapshot Method and Apparatus Based on Openstack Platform”, the disclosure of which is hereby incorporated by reference in its entirety.

### TECHNICAL FIELD

The present disclosure relates to the field of snapshots, and in particular, to a hard disk snapshot method and apparatus based on Openstack platform.

### BACKGROUND

Openstack platform is an open-source cloud platform software technology that provides an operating platform and toolset for deploying clouds, is a cloud platform that provides users with integrated virtualized computing services, storage services and network services, has a reliable cloud deployment embodiment and desirable scalability, and is an operating system of the cloud computing era.

Snapshots, as a form of data disaster recovery, are an effective data protection measure that may provide protection for source data to a certain extent. For example, in the cloud platform, for a scenario of a running virtual machine with a data disk mounted, data is written in the data disk, and a snapshot is taken at t1; after a period of time, at the moment t2, the data disk is corrupted, then the data may be recovered by using the snapshot at the moment t1; and in this case, the lost data is the data within (t2-t1), and the data is recovered to a data state at the moment t1, such that data loss may be minimized as much as possible.

The current Openstack native interface does not support cross-storage creation in response to creating cloud hard disks on the basis of snapshots. The core reason is that key actions of snapshot mounting and data copy are not implemented in the current native logic to support such operations. The problems in the related art lie in that, the cloud hard disk and the corresponding snapshot are stored in the same set of backend storage, in response to there are problems in the backend storage, the saved data also loses its application value and cannot be used. The native Openstack native interface does not support specifying a volume type in response to creating a cloud hard disk from the snapshots, resulting in limitations that the cloud hard disk cannot be created to other storage backends in response to being created on the basis of the snapshots, such that the native interface is limited to a certain extent. Under a current cloud platform native logic, backed-up data content cannot directly mount the backed-up disk data to a cloud platform virtual machine for use, such that corresponding interfaces are not implemented, and do not conform to the design idea that each module of Openstack is independent.

In view of the problem that the Openstack native interface cannot store hard disk snapshots across backends in the related art, there is no effective solution yet.

### SUMMARY

At least some embodiments of the present disclosure provide a hard disk snapshot method and apparatus based on Openstack platform, such that the hard disk snapshot can be stored across backends in Openstack platform, thereby protecting platform data, and improving the continuity and robustness of an application service.

On the basis of the above objective, a first aspect of an embodiment of the disclosure provides a hard disk snapshot method based on Openstack platform. The method includes executing the following steps.

A cloud hard disk creation request based on a snapshot is initiated, a type of a new cloud hard disk to be created is determined, and a second storage backend that is about to accommodate the new cloud hard disk is determined on the basis of the type of the new cloud hard disk.

In response to the second storage backend being different from a first storage backend where an old cloud hard disk that stores the snapshot is located, one host machine is determined, and the old cloud hard disk is mounted on the host machine.

The new cloud hard disk is created on the second storage backend on the basis of the type of the new cloud hard disk, and the new cloud hard disk is mounted on the host machine.

The snapshot is replicated from the old cloud hard disk to the new cloud hard disk through the host machine.

In some embodiments, the new cloud hard disk comes in a variety of types, an Openstack platform has multiple storage backends, and the variety of types have a one-to-one correspondence relationship with the multiple storage backends. The step of determining, on the basis of the type of the new cloud hard disk, the second storage backend that accommodates the new cloud hard disk includes: on the basis of the one-to-one correspondence relationship, a storage backend corresponding to the type of the new cloud hard disk is determined as the second storage backend.

In some embodiments, the method further includes: before determining the type of the new cloud hard disk to be created, whether it is necessary to specify the type of the new cloud hard disk is determined; and in response to that the type of the new cloud hard disk that does not need to be specified, the first storage backend is determined as the second storage backend.

In some embodiments, in response to the second storage backend being the same as the first storage backend, further including:

the new cloud hard disk is created on the first storage backend on the basis of a native interface of the Openstack platform.

The snapshot is replicated from the old cloud hard disk to the new cloud hard disk on the basis of an underlying command of the first storage backend.

In some embodiments, the step of creating the new cloud hard disk on the second storage backend on the basis of the type of the new cloud hard disk includes:

legality of the type of the new cloud hard disk is verified by using a Cinder Application Programming Interface (API) of the Openstack platform, and in response to the legality of the type, a creation request is sent to a Cinder scheduler of the Openstack platform.

The Cinder scheduler is used to create the new cloud hard disk on the second storage backend on the basis of the creation request and the type of the new cloud hard disk.

In some embodiments, the method further includes: the new cloud hard disk is mounted on the host machine by using the Cinder scheduler.

In some embodiments, the method further includes: in response to the end of replicating, the old cloud hard disk and the new cloud hard disk are uninstalled from the host machine.

A second aspect of an embodiment of the disclosure provides a hard disk snapshot apparatus based on Openstack. The apparatus includes a processor and a memory.

The memory stores a program code runnable by the processor. The program code, in response to being run, executes the following steps.

A cloud hard disk creation request based on a snapshot is initiated, a type of a new cloud hard disk to be created is determined, and a second storage backend that is about to accommodate the new cloud hard disk is determined on the basis of the type of the new cloud hard disk.

In response to the second storage backend being different from a first storage backend where an old cloud hard disk that stores the snapshot is located, one host machine is determined, and the old cloud hard disk is mounted on the host machine.

The new cloud hard disk is created on the second storage backend on the basis of the type of the new cloud hard disk, and the new cloud hard disk is mounted on the host machine.

The snapshot is replicated from the old cloud hard disk to the new cloud hard disk through the host machine.

In some embodiments, the new cloud hard disk comes in a variety of types, an Openstack platform has multiple storage backends, and the variety of types have a one-to-one correspondence relationship with the multiple storage backends. The step of determining, on the basis of the type of the new cloud hard disk, the second storage backend that accommodates the new cloud hard disk includes: on the basis of the one-to-one correspondence relationship, a storage backend corresponding to the type of the new cloud hard disk is determined as the second storage backend.

In some embodiments, the step of creating the new cloud hard disk on the second storage backend on the basis of the type of the new cloud hard disk includes:

legality of the type of the new cloud hard disk is verified by using an API of the Openstack platform, and in response to the legality of the type, a creation request is sent to a Cinder scheduler of the Openstack platform.

The Cinder scheduler is used to create the new cloud hard disk on the second storage backend on the basis of the creation request and the type of the new cloud hard disk.

The disclosure has the following beneficial technical effects. According to the hard disk snapshot method and apparatus based on Openstack provided in the embodiments of the disclosure, by means of the embodiment of initiating a cloud hard disk creation request based on a snapshot, determining the type of a new cloud hard disk to be created, and determining, on the basis of the type of the new cloud hard disk, a second storage backend that is about to accommodate the new cloud hard disk; in response to the second storage backend being different from a first storage backend where an old cloud hard disk that stores the snapshot is located, determining one host machine, and mounting the old cloud hard disk on the host machine; creating the new cloud hard disk on the second storage backend on the basis of the type of the new cloud hard disk, and mounting the new cloud hard disk on the host machine; and replicating the snapshot from the old cloud hard disk to the new cloud hard disk through the host machine, the hard disk snapshot can be stored across backends in Openstack platform, such that platform data is protected, and the continuity and robustness of an application service are improved.

### BRIEF DESCRIPTION OF THE DRAWINGS

In order to illustrate the methods in the embodiments of the disclosure or problems in the related art more clearly, the drawings used in the technical description of the embodiments will be briefly described below. It is apparent that the drawings in the following descriptions are merely some embodiments of the disclosure. Other drawings can be obtained from those skilled in the art according to these drawings without any creative work.

FIG. 1 is a schematic flowchart of a hard disk snapshot method based on Openstack platform according to the disclosure.

FIG. 2 is a detailed flowchart of a hard disk snapshot method based on Openstack platform according to the disclosure.

FIG. 3 is a schematic structural diagram of a hard disk snapshot apparatus based on Openstack platform according to the disclosure.

### DETAILED DESCRIPTION OF THE EMBODIMENTS

To make the objectives, methods and advantages of the disclosure clearer, the disclosure is further described in detail with reference to specific embodiments and the drawings.

It is to be noted that, all expressions using “first” and “second” in the embodiments of the disclosure are for the purpose of distinguishing two non-identical entities with the same name or non-identical parameters. It may be seen that “first” and “second” are only for the convenience of expression, and should not be construed as a limitation to the embodiments of the disclosure, which are not described one by one thereto in the subsequent embodiments.

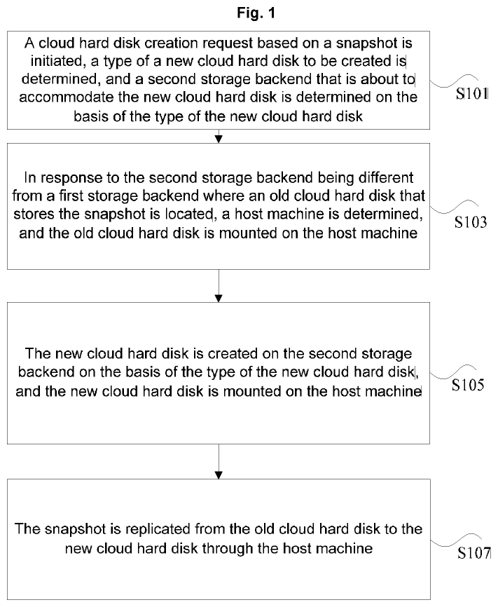

On the basis of the above objective, a first aspect of an embodiment of the disclosure provides an embodiment of a hard disk snapshot method based on Openstack platform for storing a hard disk snapshot across a backend in Openstack platform, to protect platform data. FIG. 1 is a schematic flowchart of the hard disk snapshot method based on Openstack platform according to the disclosure.

As shown in FIG. 1, the hard disk snapshot method based on Openstack platform includes executing the following steps.

At step of S101, a cloud hard disk creation request based on a snapshot is initiated, a type of a new cloud hard disk to be created is determined, and a second storage backend that is about to accommodate the new cloud hard disk is determined on the basis of the type of the new cloud hard disk.

At step of S103, in response to the second storage backend being different from a first storage backend where an old cloud hard disk that stores the snapshot is located, one host machine is determined, and the old cloud hard disk is mounted on the host machine.

At step of S105, the new cloud hard disk is created on the second storage backend on the basis of the type of the new cloud hard disk, and the new cloud hard disk is mounted on the host machine.

At step of S107, the snapshot is replicated from the old cloud hard disk to the new cloud hard disk through the host machine.

In the disclosure, the cloud hard disk creation action request based on the snapshot is first initiated, and an available cloud hard disk type is selected during creation (the cloud hard disk type being generally bound to a storage backend, that is, one cloud hard disk type corresponding to one storage backend); on the basis of the introduced cloud hard disk type, the new cloud hard disk is created on a target storage backend; the snapshot is mounted to one host machine of a cloud platform, to establish a mapping relationship; the new cloud hard disk is mounted to the host machine which establishes the mapping relationship with the snapshot, to further establish a mapping relationship; a data copy action starts to be executed, since the snapshot, also known as a source cloud hard disk, is a fully available copy, a read operation on the data may be performed, the data of an old cloud hard disk is read on the host machine side and is written into the new cloud hard disk; after the copy action is finished, the mapping relationship among the snapshot, the new cloud hard disk and the host machine is released.

Those of ordinary skill in the art may understand that all or part of the processes in the above method embodiments may be implemented by a computer program to instruct related hardware, and the program may be stored in a computer-readable storage medium. In response to the program is executed, the flow of each method embodiment as described above may be included. The storage medium may be a magnetic disk, an optical disk, a read-only memory (ROM), or a Random Access Memory (RAM), or the like. The embodiments of the computer program may achieve the same or similar effects as the corresponding any of the foregoing method embodiments.

In some embodiments, the new cloud hard disk comes in a variety of types, an Openstack platform has multiple storage backends, and the variety of types have a one-to-one correspondence relationship with the multiple storage backends. The step of determining, on the basis of the type of the new cloud hard disk, the second storage backend that accommodates the new cloud hard disk includes: on the basis of the one-to-one correspondence relationship, a storage backend corresponding to the type of the new cloud hard disk is determined as the second storage backend.

In some embodiments, the method further includes: before determining the type of the new cloud hard disk to be created, whether it is necessary to specify the type of the new cloud hard disk is determined; and in response to the type of the new cloud hard disk that do not need to be specified, the first storage backend is determined as the second storage backend.

In some embodiments, in response to the second storage backend being the same as the first storage backend further including:

The new cloud hard disk is created on the first storage backend on the basis of a native interface of the Openstack platform.

The snapshot is replicated from the old cloud hard disk to the new cloud hard disk on the basis of an underlying command of the first storage backend.

In some embodiments, the step of creating the new cloud hard disk on the second storage backend on the basis of the type of the new cloud hard disk includes:

legality of the type of the new cloud hard disk is verified by using a Cinder API of the Openstack platform, and in response to the legality of the type, a creation request is sent to a Cinder scheduler of the Openstack platform.

The Cinder scheduler is used to create the new cloud hard disk on the second storage backend on the basis of the creation request and the type of the new cloud hard disk.

In some embodiments, the method further includes: the new cloud hard disk on the host machine by using the Cinder scheduler is mounted.

In some embodiments, the method further includes: in response to the end of replicating, the old cloud hard disk and the new cloud hard disk are uninstalled from the host machine.

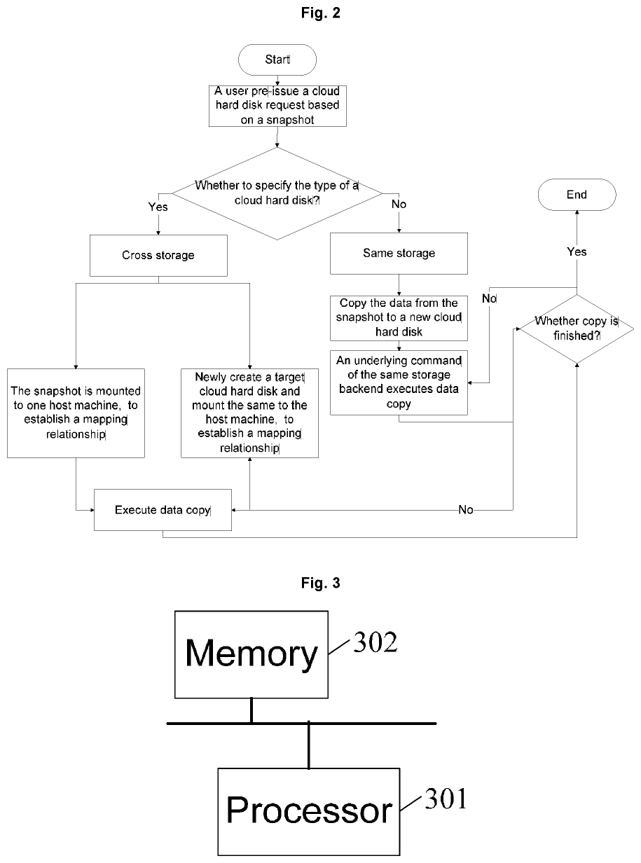

The embodiments of the disclosure are further described below with reference to the specific implementations shown in FIG. 2. Referring to FIG. 2, first, there are multiple sets of available storage backends in the Openstack platform, and then the following steps are executed.

(1) Preparation of initiating the cloud hard disk creation request based on the snapshot is started.

(2) Whether to specify a cloud hard disk type parameter (that is, whether to perform cross storage creation) is selected; in response to the cloud hard disk type parameter is selected, (3), (5), (6), (7), (8), (9) and (10) are continuously executed; and in response to the cloud hard disk type parameter isnot selected, (4) and (10) are continuously executed.

(3) A cloud hard disk type (that is, cross storage) is selected to create a new cloud hard disk.

(4) The same storage is selected; on the basis of a native interface, the new cloud hard disk is directly created into the same set of storage backends where the snapshot is located; then an underlying command executes, on the same storage backend, a data copy action from the snapshot to the new cloud hard disk, and determines whether copy is finished; and after data copy is finished, the new cloud hard disk is created.

(5) A Cinder API receives the request, verifies the legality of parameters transmitted by a user, and then issues the creation request to the Cinder scheduler.

(6) The snapshot is mounted to one host machine of a cloud platform for mapping.

(7) The Cinder scheduler creates, according to introduced cloud hard disk type parameters, the new cloud hard disk on a specified storage backend and mounts the new cloud hard disk on the same host machine in the cloud platform where the snapshot has been mapped.

(8) Execution of data copy: data is read from the snapshot and then written into the new cloud hard disk, that is, the data is copied from a source cloud hard disk to a target cloud hard disk, and whether the data is copied is synchronously determined.

(9) After data copy is finished, the mapping relationship between the snapshot and the new cloud hard disk and the cloud platform is released.

(10) End.

An embodiment of the disclosure provides a new method for creating the cloud hard disk with the snapshot. In response to the cloud hard disk is created by using the snapshot, cloud hard disk type parameters are supported, that is, a new cloud hard disk is supported to be created on other storage backends, to avoid the risk of abnormal unavailability of a source storage backend, thereby increasing a protection measure for data. In addition, insofar as a cloud platform is connected to multiple of sets of storage backend, in response to a source storage backend cluster is not available, data stored thereon cannot be normally accessed. In this case, the cloud hard disk created across storage plays an important role. Since the source storage and a target storage are both connected to the same set of cloud platform, the new cloud hard disk which is created on the basis of the snapshot of the source storage backend shows an actual application value, such that the new cloud hard disk may be directly used by resources in the cloud platform. For example, a virtual machine running services mounts a data disk of the source storage backend before; due to some abnormality, the source storage backend is not available; and in this case, the new cloud hard disk of the target storage backend that is created in advance may be directly mounted to the virtual machine for normal access of backup data, such that the continuity and robustness of services are guaranteed. From the above, it may be learned that such solution implements a redundant protection mechanism that different storage backends back each other up to a certain extent, such that the continuity and robustness of application services of a cloud platform may be realized. The existing technical means supporting the implementation of this solution is of great practical significance and can effectively provide predictable values to cloud platform users and development.

From the above embodiments, it can be seen that, according to the hard disk snapshot method based on Openstack platform provided in the embodiments of the disclosure, by means of the method of initiating the cloud hard disk creation request based on the snapshot, determining the type of the new cloud hard disk to be created, and determining, on the basis of the type of the new cloud hard disk, the second storage backend that is about to accommodate the new cloud hard disk; in response to the second storage backend being different from the first storage backend where the old cloud hard disk that stores the snapshot is located, determining the host machine, and mounting the old cloud hard disk on the host machine; creating the new cloud hard disk on the second storage backend on the basis of the type of the new cloud hard disk, and mounting the new cloud hard disk on the host machine; and replicating the snapshot from the old cloud hard disk to the new cloud hard disk through the host machine, the hard disk snapshot can be stored across backends in Openstack, such that platform data is protected, and the continuity and robustness of an application service are improved.

It is to be particularly noted that, each step in each embodiment of the hard disk snapshot method based on Openstack platform may be crossed, replaced, added, or deleted, such that these rational permutation and combination transformations for the hard disk snapshot method based on Openstack platform should also fall within the protection scope of the disclosure, and the protection scope of the disclosure should not be limited to the embodiments.

As shown in FIG. 3, on the basis of the above objective, a second aspect of an embodiment of the disclosure provides an embodiment of a hard disk snapshot apparatus based on Openstack platform for storing a hard disk snapshot across a backend in Openstack platform, to protect platform data. The hard disk snapshot apparatus based on Openstack platform includes a processor 301 and a memory 302.

The memory 302 stores a program code runnable by the processor 301. The program code, in response to being run, executes the following steps.

A cloud hard disk creation request based on a snapshot is initiated, the type of a new cloud hard disk to be created is determined, and a second storage backend that is about to accommodate the new cloud hard disk is determined on the basis of the type of the new cloud hard disk.

In response to the second storage backend being different from a first storage backend where an old cloud hard disk that stores the snapshot is located, one host machine is determined, and the old cloud hard disk is mounted on the host machine.

The new cloud hard disk is created on the second storage backend on the basis of the type of the new cloud hard disk, and the new cloud hard disk is mounted on the host machine.

The snapshot is replicated from the old cloud hard disk to the new cloud hard disk via the host machine.

In some embodiments, the new cloud hard disk comes in a variety of types, an Openstack platform has multiple storage backends, and the variety of types have a one-to-one correspondence relationship with the multiple of storage backends. The step of determining, on the basis of the type of the new cloud hard disk, the second storage backend that accommodates the new cloud hard disk includes: on the basis of the one-to-one correspondence relationship, the storage backend corresponding to the type of the new cloud hard disk is determined as the second storage backend.

In some embodiments, the step of creating the new cloud hard disk on the second storage backend on the basis of the type of the new cloud hard disk includes:

legality of the type of the new cloud hard disk is verified by using a Cinder API of the Openstack platform, and in response to the legality of the type, a creation request is sent to a Cinder scheduler of the Openstack platform.

The Cinder scheduler is used to create the new cloud hard disk on the second storage backend on the basis of the creation request and the type of the new cloud hard disk.

From the above embodiments, it can be seen that, according to the hard disk snapshot apparatus based on Openstack platform provided in the embodiments of the disclosure, by means of the method of initiating the cloud hard disk creation request based on the snapshot, determining the type of the new cloud hard disk to be created, and determining, on the basis of the type of the new cloud hard disk, the second storage backend that is about to accommodate the new cloud hard disk; in response to the second storage backend being different from the first storage backend where the old cloud hard disk that stores the snapshot is located, determining the host machine, and mounting the old cloud hard disk on the host machine; creating the new cloud hard disk on the second storage backend on the basis of the type of the new cloud hard disk, and mounting the new cloud hard disk on the host machine; and replicating the snapshot from the old cloud hard disk to the new cloud hard disk through the host machine, the hard disk snapshot can be stored across backends in Openstack, such that platform data is protected, and the continuity and robustness of an application service are improved.

It is to be particularly noted that, the embodiments of the hard disk snapshot apparatus based on Openstack platform use the embodiments of the hard disk snapshot method based on Openstack platform to specifically describe an operating process of each module. It can readily be conceivable to those skilled in the art that, these modules are applied to other embodiments of the hard disk snapshot method based on Openstack platform. Definitely, since each step in the embodiments of the hard disk snapshot method based on Openstack platform may be crossed, replaced, added, or deleted, such that these rational permutation and combination transformations for the hard disk snapshot apparatus based on Openstack platform should also fall within the protection scope of the disclosure, and the protection scope of the disclosure should not be limited to the embodiments.

The above are exemplary embodiments of the disclosure, but it should be noted that, multiple changes and modifications may be made without departing from the scope disclosed in the embodiments of the disclosure as defined in the claims. The functions, steps and/or actions of the method claims in accordance with the disclosed embodiments described herein need not be performed in any particular order. In addition, although elements disclosed in the embodiments of the disclosure may be described or claimed in the singular, unless explicitly limited to the singular, the plural may also be construed.

Those of ordinary skill in the art should understand that, the discussion of any of the above embodiments is merely exemplary, and is not intended to imply that the scope (including the claims) disclosed in the embodiments of the disclosure is limited to these examples. Under the idea of the embodiments of the disclosure, the technical features in the above embodiments or different embodiments may also be combined. In addition, there are many other changes in different aspects of the above embodiments of the disclosure, which are not provided in detail for the sake of brevity. Therefore, any omissions, modifications, equivalent replacements, improvements and the like made within the spirit and principle of the embodiments of the disclosure shall all fall within the protection scope of the embodiments of the disclosure.

1. A hard disk snapshot method based on Openstack platform, comprising:
initiating a cloud hard disk creation request based on a snapshot, determining a type of a new cloud hard disk to be created, and determining, on the basis of the type of the new cloud hard disk, a second storage backend that is about to accommodate the new cloud hard disk;
in response to the second storage backend being different from a first storage backend where an old cloud hard disk that stores the snapshot is located, determining one host machine, and mounting the old cloud hard disk on the host machine;
creating the new cloud hard disk on the second storage backend on the basis of the type of the new cloud hard disk, and mounting the new cloud hard disk on the host machine; and
replicating the snapshot from the old cloud hard disk to the new cloud hard disk through the host machine.

2. The method as claimed in claim 1, wherein the new cloud hard disk comes in a variety of types, an Openstack platform has multiple storage backends, and the variety of types have a one-to-one correspondence relationship with the multiple storage backends, determining, on the basis of the type of the new cloud hard disk, the second storage backend that accommodates the new cloud hard disk comprises:
on the basis of the one-to-one correspondence relationship, determining, as the second storage backend, a storage backend corresponding to the type of the new cloud hard disk.

3. The method as claimed in claim 2, further comprising:
before determining the type of the new cloud hard disk to be created, determining whether it is necessary to specify the type of the new cloud hard disk; and in response to that the type of the new cloud hard disk that does not need to be specified, determining the first storage backend as the second storage backend.

4. The method as claimed in claim 1, in response to the second storage backend being the same as the first storage backend, further comprising:
creating the new cloud hard disk on the first storage backend on the basis of a native interface of the Openstack platform; and
replicating the snapshot from the old cloud hard disk to the new cloud hard disk on the basis of an underlying command of the first storage backend.

5. The method as claimed in claim 1, wherein creating the new cloud hard disk on the second storage backend on the basis of the type of the new cloud hard disk comprises:
verifying legality of the type of the new cloud hard disk by using a Cinder Application Programming Interface (API) of the Openstack platform, and in response to the legality of the type, sending a creation request to a Cinder scheduler of the Openstack platform; and
using the Cinder scheduler to create the new cloud hard disk on the second storage backend on the basis of the creation request and the type of the new cloud hard disk.

6. The method as claimed in claim 5, further comprising:
mounting the new cloud hard disk on the host machine by using the Cinder scheduler.

7. The method as claimed in claim 1, further comprising:
in response to the end of replicating, uninstalling the old cloud hard disk and the new cloud hard disk from the host machine.

8. A hard disk snapshot apparatus based on Openstack platform, comprising:
a processor; and
a memory, storing a program code runnable by the processor, wherein the program code, in response to being run, executes the following steps:
initiate a cloud hard disk creation request based on a snapshot, determine the type of a new cloud hard disk to be created, and determine, on the basis of the type of the new cloud hard disk, a second storage backend that is about to accommodate the new cloud hard disk;
in response to the second storage backend being different from a first storage backend where an old cloud hard disk that stores the snapshot is located, determine a host machine, and mount the old cloud hard disk on the host machine;
create the new cloud hard disk on the second storage backend on the basis of the type of the new cloud hard disk, and mount the new cloud hard disk on the host machine; and
replicate the snapshot from the old cloud hard disk to the new cloud hard disk through the host machine.

9. The apparatus as claimed in claim 8, wherein the new cloud hard disk comes in a variety of types, an Openstack platform has a multiple storage backends, and the variety of types have a one-to-one correspondence relationship with the multiple storage backends, determine, on the basis of the type of the new cloud hard disk, a second storage backend that accommodates the new cloud hard disk comprises:
on the basis of the one-to-one correspondence relationship, determine, as the second storage backend, the storage backend corresponding to the type of the new cloud hard disk.

10. The apparatus as claimed in claim 8, wherein create the new cloud hard disk on the second storage backend on the basis of the type of the new cloud hard disk comprises:
verify legality of the type of the new cloud hard disk by using a Cinder Application Programming Interface (API) of the Openstack platform, and in response to the legality of the type, send a creation request to a Cinder scheduler of the Openstack platform; and
use the Cinder scheduler to create the new cloud hard disk on the second storage backend on the basis of the creation request and the type of the new cloud hard disk.

11. The method as claimed in claim 1, wherein after the old cloud hard disk is mounted on the host machine, further comprising:
establishing a mapping relationship between the old cloud hard disk and the host machine.

12. The method as claimed in claim 1, wherein after the new cloud hard disk is mounted on the host machine, further comprising:
establishing a mapping relationship between the new cloud hard disk and the host machine.

13. The method as claimed in claim 1, wherein replicating the snapshot from the old cloud hard disk to the new cloud hard disk through the host machine comprises:
reading the snapshot of the old cloud hard disk on the host machine side; and
writing the snapshot to the new cloud hard disk.

14. The apparatus as claimed in claim 8, when the program code is executed, it performs the following steps:
before determine the type of the new cloud hard disk to be created, determine whether it is necessary to specify the type of the new cloud hard disk; and in response to that the type of the new cloud hard disk that does not need to be specified, determine the first storage backend as the second storage backend.

15. The apparatus as claimed in claim 8, in response to the second storage backend being the same as the first storage backend, when this program code is executed, it performs the following steps:
create the new cloud hard disk on the first storage backend on the basis of a native interface of the Openstack platform; and
replicate the snapshot from the old cloud hard disk to the new cloud hard disk on the basis of an underlying command of the first storage backend.

16. The apparatus as claimed in claim 10, when the program code is executed, it performs the following steps:
mount the new cloud hard disk on the host machine by using the Cinder scheduler.

17. The apparatus as claimed in claim 8, when the program code is executed, it performs the following steps:
in response to the end of replicating, uninstall the old cloud hard disk and the new cloud hard disk from the host machine.

18. The apparatus as claimed in claim 8, wherein after the old cloud hard disk is mounted on the host machine, when the program code is executed, it performs the following steps:
establish a mapping relationship between the old cloud hard disk and the host machine.

19. The apparatus as claimed in claim 8, wherein after the new cloud hard disk is mounted on the host machine, when the program code is executed, it performs the following steps:
establish a mapping relationship between the new cloud hard disk and the host machine.

20. The apparatus as claimed in claim 8, when the program code is executed, it performs the following steps:
read the snapshot of the old cloud hard disk on the host machine side; and
write the snapshot to the new cloud hard disk.
